(19) United States
(12) Patent Application Publication
(10) Pub. No.: US 2009/0106079 A1
(43) Pub. Date: Apr. 23, 2009

(54) Executive Field Service Task Start to Finish

(75) Inventors: Hari K. Gutlapalli, Union City, CA (US); Sridhar Tadepalli, Foster City, CA (US); Arnold C. Espos, Oakland, CA (US); Satheesh Challaveera, Fremont, CA (US); Ajay A. Awatramani, San Francisco, CA (US); Gajanan D. Bhat, Mountain View, CA (US); Kishore Lakshminarayanan, Santa Clara, CA (US)

Correspondence Address: CAMPBELL STEPHENSON LLP, 11401 CENTURY OAKS TERRACE, BLDG. H, SUITE 250, AUSTIN, TX, 78758, US

(73) Assignee: ORACLE INTERNATIONAL CORPORATION, Redwood Shores, CA (US)

(21) Appl. No.: 12/254,407

(22) Filed: Oct. 20, 2008

Related U.S. Application Data
(60) Provisional application No. 60/981,182, filed on Oct. 19, 2007.

(51) Int. Cl. G06Q 30/00; G06Q 10/00

(52) U.S. Cl. 705/9; 705/34

(57) ABSTRACT

Method and apparatus for completing a field service activity, where the field service activity typically involves providing on-site service for equipment or machinery. A user is presented with a sequence of operations in order to streamline the process of completing a field service activity. The user enters data and proceeds through the sequence of operations to complete the field service activity. The time spent by the user in various stages of completion of the field service activity is captured and recorded. The method optionally includes obtaining approval and signatures authorizing the agreement.

This application claims the benefit, under 35 U.S.C. § 119 (e), of U.S. Provisional Application No. 60/981,182, filed Oct. 19, 2007, entitled “Method and System for Completing Field Service Operations,” and naming Hari K. Gutlapalli, Sridhar Tadepalli, Arnold Espos, Satheesh Challaveera, Ajay Awatramani, Gajanan Bhat, and Kishore Lakshminarayanan as inventors. The above-referenced application is hereby incorporated by reference herein in its entirety.

### FIELD OF THE INVENTION

The present invention relates to completion of a field service activity, and, more particularly, to a method and apparatus for guiding a user through a sequence of operations to complete a field service activity which minimizes unnecessary task repetition.

### BACKGROUND OF THE INVENTION

In today's world, on-site service is an integral component of the success of many businesses. Any equipment imaginable may require service and maintenance. Performing the service where the equipment is located (on-site), instead of transporting the equipment to a service or repair center is a great convenience in many cases. On-site service can be performed in-house. For example, a company's employees may be responsible for servicing the company's equipment. Alternatively, on-site service may be obtained from an outside party. For example, on-site service contracts are often included in the sale and lease of commercial, government, and private goods and equipment.

When on-site service is to be performed for a piece of equipment, a field service engineer or field service technician proceeds to the site where the equipment is located and performs the service, whether it be maintenance, repair, or replacement of the equipment. The number of tasks a field service engineer may be called upon to perform can be large. The field service engineer can be called upon to perform a wide variety of tasks on a broad range of equipment. The field service engineer must not only be capable of performing the actions required for a given piece of equipment, but the field service engineer may also need to be aware of specific customer preferences for the equipment.

In order to operate efficiently and effectively, field service engineers often require extensive training and experience. Developing such expertise can be time consuming and expensive. Job turnover makes it challenging to provide a reliable and efficient staff of field service engineers.

Computers are increasingly used as a tool to assist field service engineers in completing field service activities. However, given the complexity of many of today's computer systems, computers may also present an obstacle to efficient and effective completion of a field service activity. Today's computer systems often require extensive and repetitive navigation through various screens and views. Such procedures, in addition to being inefficient, are often not intuitive and require a field service engineer to have even more training and experience than before.

What is needed is a way to reduce inefficiency in using a computer to aid in the completion of a field service activity. This would reduce the training and experience required for a field service engineer to effectively perform field service activities. This reduction in the amount of training and experience needed can lead to significant cost savings to the organization providing the field service and the customers obtaining the service.

### SUMMARY OF THE INVENTION

In one embodiment, a method is provided that includes presenting a list of one or more field service activities to a user, for example a field service engineer or technician. Each field service activity in the list has a plurality of actions associated with the field service activity. The actions associated with each field service activity are performed in a defined sequence to complete that field service activity. The user selects one of the field service activities. An action associated with the selected field service activity is presented to the user. The user enters data for the presented action. In response to the entered data, a next action is automatically selected and presented to the user.

One embodiment presents a user with sequence of operations. The operations are presented to the user in a logical progression which guides the user through performance of a field service activity, from start to finish. This can reduce the time taken to execute complex, repeatable activities by guiding the user through screens/views in which multiple records can be entered in a way that is simpler, easier, and faster than manually navigating through individual screens.

As a user completes each operation, the user enters information relating to that operation into a computer. Based, in part, on the user's input, the next operation in the process of completing the field service activity is presented on the user's screen. The process continues until the field service activity is complete.

In one embodiment, the user enters the user's status (en route, in process, done, and so on.) Entering a status triggers the capture of the time at which the status is entered. The time is automatically stored locally and can be used for record keeping, process improvement, and billing purposes, among others.

Status information and other information, such as time or data entered by a user, is stored locally until the field service activity is complete or is put on hold. At that time local storage can be synchronized with a database. Data thus stored locally is referred to as transient. Keeping data in a transient state facilitates a user being able to stop and resume field service activities in an efficient manner. If the data were flushed to a central database prior to completion of the field service activity, there is a danger that the data in the database could be inadvertently changed (e.g., deleted or overwritten) while the field service activity was interrupted. This could make resumption of the field service activity at the same point impractical or impossible.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIG. 1 is a block diagram illustrating a network environment in which a field service activity can be completed according to one embodiment.

FIG. 2 is a block diagram illustrating a computer system that can be used in completing a field service activity according to one embodiment.

FIG. 3 is a block diagram illustrating various submodules of a workflow module according to one embodiment.

FIG. 4 is a flowchart showing a high level view of the process of completing a field service activity according to one embodiment.

FIG. 5 is a flow diagram showing a detail view of the check/acknowledge activity operation of FIG. 4 according to one embodiment.

FIG. 6 is an example screenshot showing the view activity detail operation of FIG. 5 according to one embodiment.

FIG. 7 is an example screenshot showing the parts inventory operations of FIG. 5 according to one embodiment.

FIG. 8 is an example screenshot showing the update status operation of FIG. 5 according to one embodiment.

FIG. 9 is a flowchart showing a detail view of the perform activity operation of FIG. 4 according to one embodiment.

FIG. 10 is an example screenshot showing the review instructions operation of FIG. 9 according to one embodiment.

FIG. 11 is a flowchart showing a detail view of the capture activity details operation of FIG. 4 according to one embodiment.

FIG. 12 is an example screenshot showing the record type of action operation of FIG. 11 according to one embodiment.

FIG. 13 is an example screenshot showing the record parts used operation of FIG. 11 according to one embodiment.

FIG. 14 is a flowchart showing a detail view of the invoice activity operation of FIG. 4 according to one embodiment.

FIG. 15 is an example screenshot showing the enter expenses operation of FIG. 14 according to one embodiment.

FIG. 16 is an example screenshot showing the generate invoice operation of FIG. 14 according to one embodiment.

FIG. 17 is an example screenshot showing the capture signature operation of FIG. 14 according to one embodiment.

### DETAILED DESCRIPTION

The following is intended to provide a detailed description of an example of the invention and should not be taken to be limiting of the invention itself. Rather, any number of variations may fall within the scope of the invention which is defined in the claims following the description.

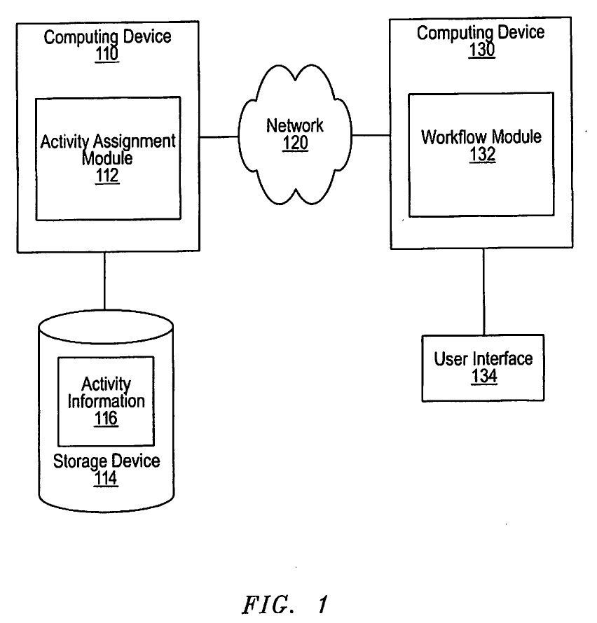

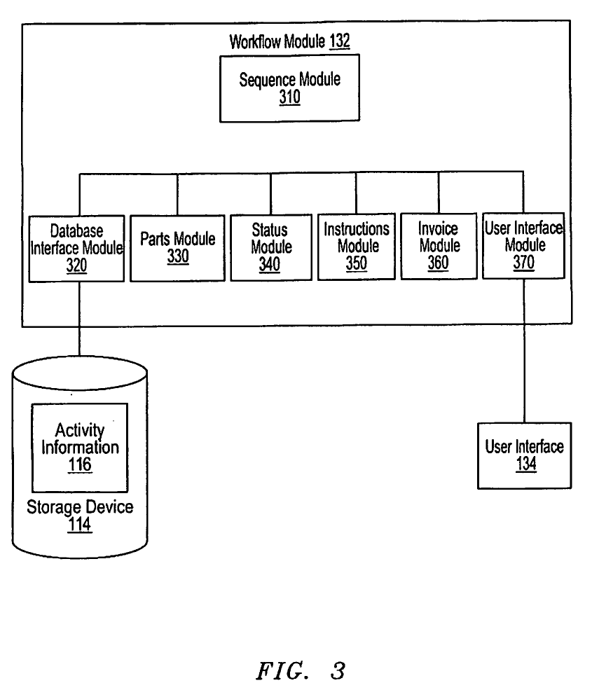

FIG. 1 is a block diagram illustrating a network environment in which a system is implemented for executing field service activities. As shown, the system includes a computing device 110. Computing device 110 implements an activity assignment module 112. Computing device 110 is shown coupled to a storage device 114. Storage device 114 can be implemented using any storage technology, including hard disks, RAM disks, optical disks, tape or other media and can contain field service activity related information such as activity information 116. Computing device 110 is also shown coupled to a network 120. Network 120 can include one or more Local Area Networks (LANs) and/or Wide Area Networks (WANs) such as the Internet. Network 120 can be implemented using various wireless links, coaxial cables, fiber optic cables, and the like. A computing device 130 is also coupled to network 120. Computing device 130 implements a workflow module 132 (discussed further with respect to FIG. 3). Computing device 130 is also shown coupled to a user interface 134, which preferably includes a display screen.

Both computing devices 110 and 130 can include one or more servers, personal computers, cell phones, laptop computers, personal digital assistants, or other computing devices capable of implementing a field service activity execution system in hardware and/or software. It is noted that in alternative embodiments, instead of being implemented on separate computing devices from each other, activity assignment module 112 and workflow module 132 can be implemented on the same computing device.

As noted, in one embodiment, computing device 110 implements activity assignment module 112. Activity assignment module 112 provides information regarding assigned field service activities, for example, to workflow module 132. This information can include, for example, a list of one or more field service activities and the field service engineer the field service activities are assigned to. Activity assignment module 112 also collects information related to field service activities, for example, from workflow module 132 and stores the collected information, for example in activity information 116. This information can include, for example, information indicating that one or more field service activities has been completed.

As shown, the system of FIG. 1 includes only one workflow module, but it will be understood in light of the present disclosure that more than one workflow module can be included in the system of FIG. 1. In the case of multiple workflow modules, activity information 116 can serve as a central repository, providing information to and receiving information from the several workflow modules. For example, there can be several computing devices (e.g., laptop computers), such as computing device 130, each used by a field service engineer (user). One or more of the users using a computing device 130 (which includes a workflow module 132) can log into computing device 110 from computing device 130. The user(s) can upload information indicating the completion of one or more field service activities. The information can be stored in activity information 116 by activity assignment module 112 for each field service activity entered by each user. The previous example is only one embodiment of a number of possible embodiments.

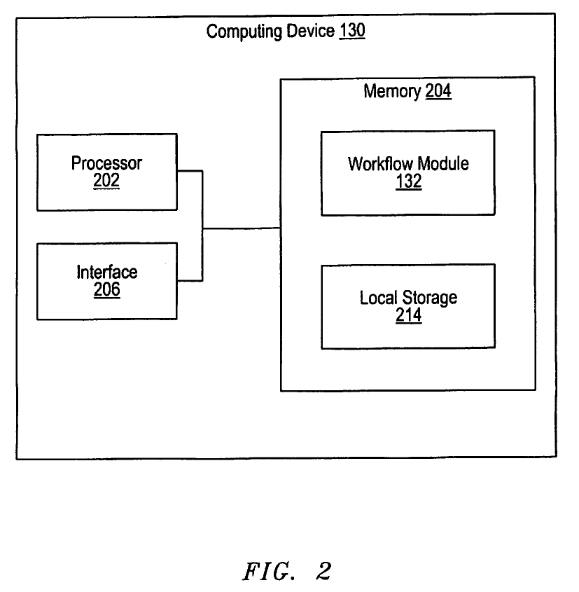

FIG. 2 is a block diagram of a computing device that illustrates how a system for executing field service activities can be implemented in software. The computing device shown in FIG. 2 can be used to implement all or part of a workflow module 132. While the illustrated example shows a single module executing on a single computing device, it is noted that in alternative embodiments, the functionality included within workflow module 132 can be subdivided among multiple modules, each of which can be implemented on a separate computing device.

Computing device 130 includes one or more processors 202 (e.g., microprocessors, Programmable Logic Devices (PLDs), or Application Specific Integrated Circuits (ASICs)) configured to execute program instructions stored in memory 204. Memory 204 can include various types of RAM (Random Access Memory), Read Only Memory (ROM), Flash memory, Micro Electro-Mechanical Systems (MEMS) memory, magnetic core memory, and the like. Memory 204 can include both volatile and non-volatile memory, and includes a local storage area 214. Computing device 130 also includes one or more interfaces 206. Processor 202, interface 206, and memory 204 are coupled by a bus or other interconnect to send and receive data and control signals.

Interface 206 can include a network interface to various networks and/or interfaces to various peripheral buses. For example, interface 206 can include a network interface via which workflow module 132 sends and receives field service activity assignments. Interface 206 can also include an interface to one or more storage devices. For example, workflow module 132 can access field service activity information (e.g., activity information 116) stored on such a storage device.

In one embodiment, program instructions and data executable to implement all or part of workflow module 132 are stored in memory 204. The program instructions and data implementing workflow module 132 can be stored on various computer readable storage media such as memory 204. In some embodiments, such software is stored on a computer readable medium such as a Compact Disc (CD), Digital Versatile Disc (DVD), hard disk, optical disk, tape device, floppy disk, and the like). In order to be executed by processor 202, the instructions and data can be loaded into memory 204 from the other computer readable storage medium. The instructions and/or data can also be transferred to computing device 130 for storage in memory 204 via a network such as the Internet or upon a carrier medium. It is appreciated that operations discussed herein may consist of directly entered commands by a computer system user or by operations executed by application specific hardware modules, but the preferred embodiment includes operations executed by software modules. The functionality of operations referred to herein may correspond to the functionality of modules or portions of modules.

These operations may be modules or portions of modules (e.g., software, firmware or hardware modules). For example, although the described embodiment includes software modules and/or includes manually entered user commands, the various example modules may be application specific hardware modules. The software modules discussed herein may include script, batch or other executable files, or combinations and/or portions of such files. The software modules may include a computer program or subroutines thereof encoded on computer-readable media.

Additionally, those skilled in the art will recognize that the boundaries between modules are merely illustrative and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, those skilled in the art will recognize that the operations described in example embodiment are for illustration only. Operations may be combined or the functionality of the operations may be distributed in additional operations in accordance with the invention.

The software modules described herein may be received by a computer system, for example, from computer readable media. The computer readable media may be permanently, removably or remotely coupled to the computer system. Such computer readable media can include, for example: magnetic storage media including disk and tape storage media; optical storage media such as compact disk media (e.g., CD-ROM, CD-R, etc.) and digital video disk storage media; nonvolatile memory storage memory including semiconductor-based memory units such as FLASH memory, EEPROM, EPROM, ROM or application specific integrated circuits; volatile storage media including registers, buffers or caches, main memory, RAM, and the like; and data transmission media including computer network, point-to-point telecommunication, and carrier wave transmission media. In a UNIX-based embodiment, the software modules may be embodied in a file which may be a device, a terminal, a local or remote file, a socket, a network connection, a signal, or other expedient of communication or state change. Other new and various types of computer-readable media can be used to store and/or transmit the software modules discussed herein.

Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like. Each of the processes described herein can be executed by a module (e.g., a software module) or a portion of a module or a computer system such as, for example, the computing device shown in FIG. 2.

FIG. 3 shows a block diagram of workflow module 132, according to one embodiment. In this example, workflow module 132 consists of various submodules configured to provide functionality related to executing field service activities. These submodules include, in one embodiment, a sequence module 310 coupled to a database interface module 320, a parts module 330, a status module 340, an instructions module 350, an invoice module 360, and a user interface module 370. Other embodiments can include additional submodules or fewer submodules.

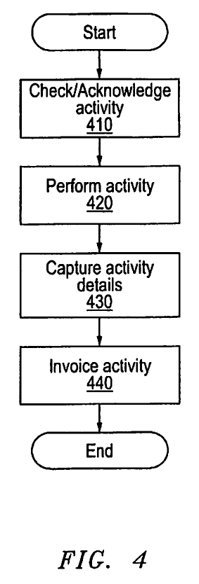

In one embodiment, sequence module 310 guides a user through the process of completing a field service activity. As discussed with respect to FIG. 4 and subsequent figures, the process can include receiving an assignment indicating an activity and instructions to complete the activity. The process also includes performing the activity itself, whether the activity is a repair or replacement of a piece of equipment, for example. Typically the process also includes entering details regarding the activity into a computer and generating an invoice. Sequence module 310 can support a complete process or any portion thereof. The number of operations needed to complete a field service activity and which operations are required is determined in part based on user input. Certain operations may be omitted based on user input. Sequence module 310 may also be configured such that certain operations are always required. Sequence module 310 keeps track of which operation the process is currently on. When a user inputs information related to a field service activity, sequence module 310 determines, based on the input, the current operation, and the like, the appropriate next operation and advances the process to that operation. Which operation is next may be different if the user input is different, meaning that certain operations will be performed in the completion of some field service activities and not in others, depending on user input. However, the user does not have to make such decisions.

In one embodiment, a user accesses the system through user interface 134. Via user interface 134, the user can input information relating to the operations of the field service activity being completed. User interface module 370 captures the information and transfers the information to the appropriate submodules, including sequence module 310. Sequence module 310 then determines the next step in the process and advances the process. For example, the user can click a button on the user interface which indicates the process should be advanced to the next operation. The sequence module performs the processing and determinations discussed above and advances the process. When the process is advanced, the user is presented with a different view having fields in which to supply information associated with the new operation. In some embodiments, a user can manually control the sequence of operations, thus avoiding one or more automated, guided steps.

The selection of the next operation, for a given present operation and input combination, is configurable. For example, in one embodiment, if a user makes a particular selection, or inputs certain information, the sequence module would advance the process to a particular next operation in the sequence. However, other embodiments can be configured such that the same selection or input would result in the sequence module advancing the process to a different next operation in the sequence, resulting in a different overall sequence of operations. Such configuration can be performed, for example, by an administrator or organization deploying the field service activity completion system.

For each field service activity type that can be completed using the system, there can be a distinct sequence. This sequence can be unique to a particular organization, or can change over time, e.g., with changes in the organization's policies. For example, a policy change at an organization can require that the sequence of operations performed to complete a given field service activity be changed. Similarly, the sequence performed with respect to a given piece of equipment may require modification. The sequence for each activity type, or piece of equipment, can be modified, for example by adding or removing required operations, or changing the order in which the operations of the sequence are performed. Such configuration can be performed, for example, by an administrator.

Database interface module 320 is configured to send information to and receive information from a remote storage system (e.g., storage device 114). Remote means, in this context, a storage device not included in the computing device implementing workflow module 132. If a submodule of workflow module 132 requires information (e.g., from activity information 116), that submodule can send a request to database interface module 320. Database interface module 320 can retrieve the requested information from activity information 116 and return the information to the requesting submodule. Also, if a submodule of workflow module 132 needs to store information in storage device 114, database interface module 320 can access storage device 114 and store the information therein. Although FIG. 3 shows database interface module 320 directly coupled to storage device 114, database interface module 320 need not be so coupled. In some embodiments, database interface module 320 sends information to and receives information from storage device 114 via another computing device (e.g., computing device 110 of FIG. 1).

Parts module 330 receives (e.g., from sequence module 310) a selected field service activity name. Parts module 330 provides information regarding parts used to complete the selected field service activity. Parts module 330 can provide a list of all parts needed to complete the field service activity. Parts module 330 can also provide inventory information regarding parts. For example, if a field service activity requires a certain part, parts module 330 can indicate that the part is required and can also indicate that the inventory is in stock in a warehouse, was issued to a field service engineer, or is out of stock, to name a few examples. If the part is out of stock, parts module 330 can automatically submit an order to replenish the stock. Information accessed by parts module 330 can be stored remotely, (e.g., in activity information 116) or locally (e.g., in local storage 214 of FIG. 2). If the information is stored remotely, parts module 330 can request the information from database interface module 320.

Status module 340 receives input (e.g., from user interface 134) concerning a user's status with respect to a given field service activity. Possible values a user can enter include, for example, “En route,” “In process,” “On hold,” and “Complete,” or the like. When a user inputs a new status, that status becomes active and status module 340 updates a time value. The time value can be used to calculate the time each status is active. For example, the total amount of time that the process status was set to “En route” can be calculated. The calculated value can be used for record keeping, billing, process improvement, and the like. Status module 340 can store such status information remotely, (e.g., in activity information 116) or locally (e.g., in local storage 214 of FIG. 2). In one embodiment, status information is stored locally until the field service activity is completed or placed on hold, at which time the status information is transferred to database interface module 320 to be stored in storage device 114.

Instructions module 350 receives (e.g., from sequence module 310) a selected field service activity name. Instructions module 350 retrieves instructions that can be followed to complete the field service activity. The instructions can be retrieved from remote storage, (e.g., activity information 116) or local storage (e.g., local storage 214 of FIG. 2). The instructions are transferred to user interface module 370 to be displayed to a user via user interface 134.

Invoice module 360 totals charges for a given field service activity. In one embodiment this includes receiving expenses entered by a user (e.g., via user interface 134), receiving cost of parts and materials (e.g., from parts module 330), and calculating labor charges (e.g., based on information received from status module 340). These and other charges can be used to fill in fields of an invoice that is to be presented to a customer. The invoice can be printed out for the customer's signature, or the customer's signature can be captured electronically by invoice module 360. Invoice module 360 can digitize the captured signature and associate the digitized signature with the invoice. Invoice module 360 is also configured to associate a digital signature with an invoice. Invoice module 360 sends captured signature information to database interface module 320 to be stored, for example in storage device 114.

In one embodiment, a user interacts with the system via user interface 134. A user interface module 370 generates views to be displayed via user interface 134, and captures information entered by a user of user interface 134. In one embodiment, user interface 134 is presented as a set of web pages having interactive controls. When sequence module 310 determines what operation the process is on, sequence module 310 instructs user interface module 370 to display information related to that operation. For example, user interface module 370 can cause user interface 134 to display a list of field service activities assigned to a user. The user can view the list and select a field service activity from the list. The user can input the selection in the form of, for example, clicking a button, selecting an item from a drop-down menu, or entering text. User interface module 370 passes the input to the appropriate submodules, for example, sequence module 310. User interface module also causes user interface 134 to present the next set of fields for user input, as determined by sequence module 310.

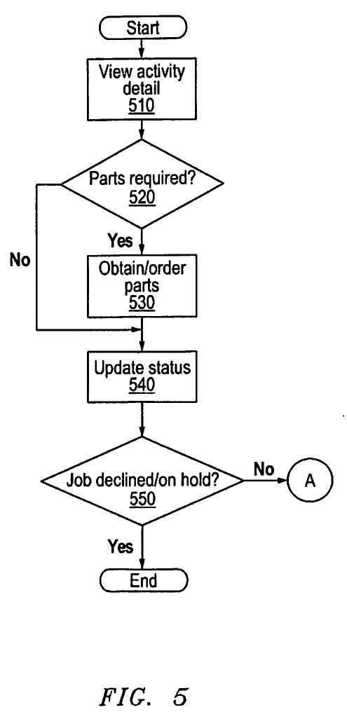

FIG. 4 is a flow diagram showing a high level view of completing a field service activity according to one embodiment. The process of FIG. 4 begins with a check/acknowledge activity operation (operation 410). Once the actions of operation 410 (discussed in more detail with reference to FIG. 5) have been completed, a user (e.g., a field service engineer) proceeds to the site of the equipment the field service activity is to be performed on and performs the field service activity (operation 420.) The details regarding the field service activity are captured in operation 430. Finally, after the field service activity is invoiced (operation 440), the process ends.

FIG. 5 is a flow diagram showing a detail view of the check/acknowledge activity operation of FIG. 4 according to one embodiment. In one example, a user uses a laptop computer to access a user interface (e.g., user interface 134 of FIG. 1) and logs in to the system for completing field service activities. Once the user is logged in, a user interface module (e.g., via user interface module 370 of FIG. 3) can capture the user identity of the user. Based on the user's identity, a sequence module (e.g., sequence module 310 of FIG. 3) can determine which field service activities should be presented to the user. For example, the sequence module can access local storage to determine whether any field service activities assigned to the user are stored therein. The sequence module can also access a remote storage device (e.g. storage device 114 of FIG. 1) to determine whether the remote storage device contains any activities that should also be presented to the user. If there are activities stored in remote storage that are not stored in local storage that should be presented to the user, the sequence module can instruct a database interface module (e.g., database interface module 320 of FIG. 3) to transfer the field service activities to local storage.

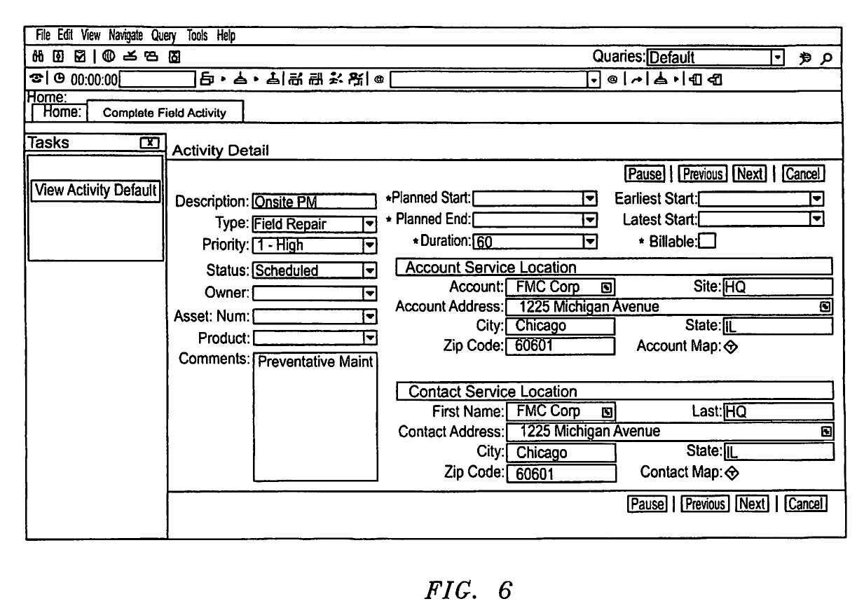

In operation 510, the user is presented with a list of field service activities. The activities in the list can be field service activities assigned to the user. The field service activities can be grouped according to criteria such as priority, type of activity, location, or status, to name a few. Using the user interface, the user selects a field service activity from the list. The user interface module captures the user's selection and transfers the selection to the sequence module. The sequence module identifies any information associated with the field service activity and causes the user interface module to display the associated information via the user interface. The information comprises the details of the selected field service activity, and can include information about the type of equipment to be serviced, the location of the equipment, information concerning scheduling the service, special instructions (e.g., specific requests from the customer), and the like, as seen in FIG. 6.

FIG. 6 is an example screenshot showing various fields associated with the view activity detail operation 510 of FIG. 5. FIG. 6 shows a set of buttons which the user can use to navigate through a predefined sequence of operations to complete the field service activity. For example, clicking the “Next” button causes the sequence module to determine the next operation in the sequence and advance the process to that operation.

Clicking “Next” from the view activity operation 510, causes the sequence module to advance the process to an operation 520. At operation 520, the sequence module invokes a parts module (e.g., parts module 330 of FIG. 3) to determine whether parts or supplies are required to complete the selected field service activity and whether the user needs to obtain any parts or supplies to complete the selected field service activity. The parts module compiles a list of parts needed for the selected field service activity and compares the list with the parts in inventory. The inventory may be inventory on a given field service engineer's truck, or at an office or warehouse. The parts module can, if needed, communicate with remote storage via the database interface module to perform the checks of inventory. If parts are needed which are not in stock, the user can elect to order them at operation 530. Alternatively, the parts module can automatically order parts, for example, to keep a specified number of each part in inventory. In one embodiment, an administrator specifies level of stock desired in inventory.

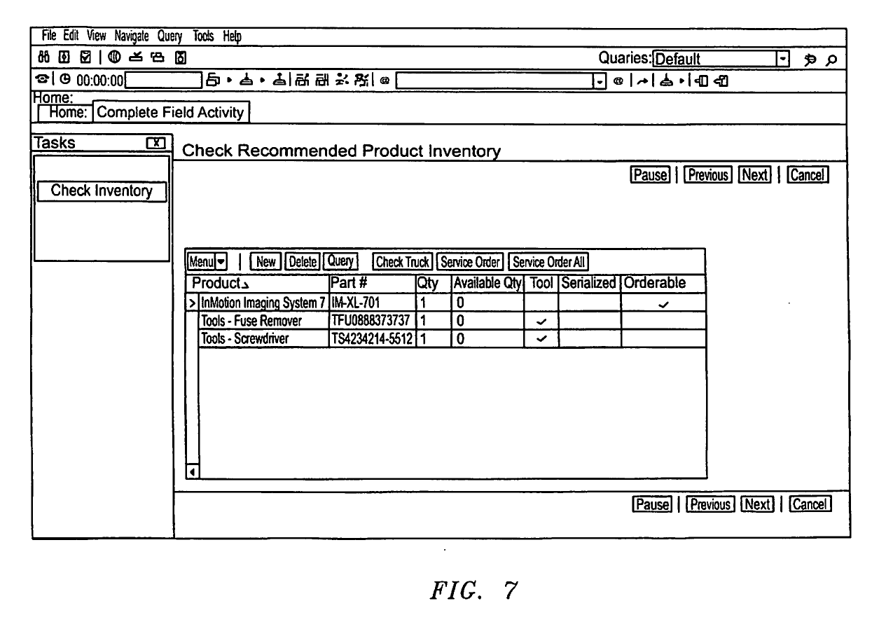

FIG. 7 is an example screenshot showing the parts inventory operations of FIG. 5. As can be seen, the user is presented with a list of parts required for the field service activity. The user has the option of adding parts to the list or removing parts from the list. The user can also query the parts module, for example to see if substitute parts are available for an out of stock part. The user has the option to pause the field service activity completion process, for example, if a part is out of stock and will not be available in a timely fashion, or if checking to see if the part is available requires a delay. Once the out of stock part(s) becomes available, the user can resume the field service activity completion process at the same point the user left off.

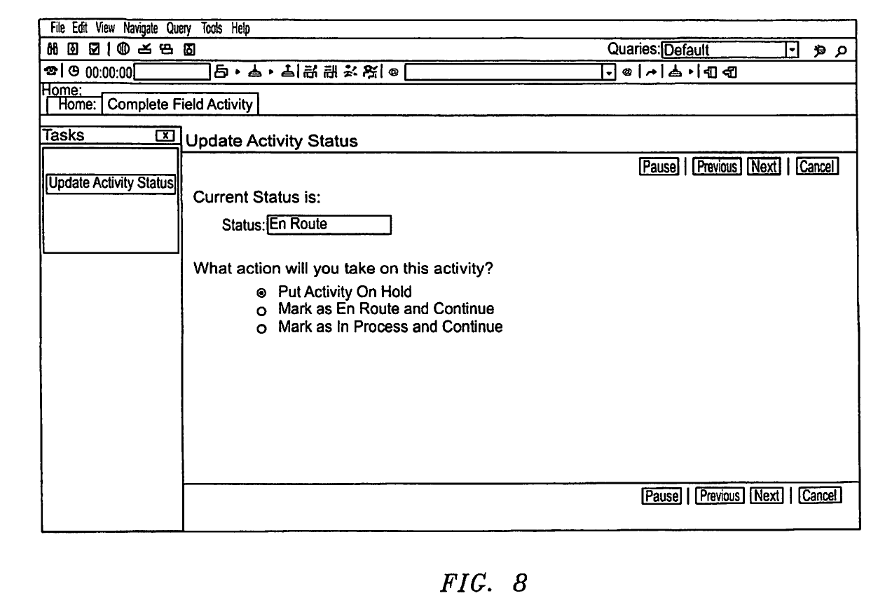

After making sure the requisite parts are available, the next operation is for the user to update the user's status (operation 540). FIG. 8 is an example screenshot showing the update status operation of FIG. 5. Updating the user's status includes selecting whether the user will accept the field service activity (i.e., whether the user will begin or continue the process of completing the field service activity). If the user does not accept the field service activity, the user can put the field service activity on hold. For example, if parts are not available, the user may elect to place the field service activity on hold until the needed parts can be obtained. The user can also set status to “En route,” or “In process.” These are merely examples of possible status indications which the user can select. In other embodiments, other selections are available.

The status selected by the field service engineer is captured by the user interface, and transferred from the user interface module to a status module (e.g., status module 340 of FIG. 3). The status module preferably stores the status information in local storage, though the status module can transfer the status information to the database interface module for storage in remote storage. The status module also keeps track of how long each status is active. For example, if the user selects “En route” as the status at time A, and then changes status to “In progress” at time B, the status module calculates time A minus time B and stores the difference as the amount of time spent “En route.” This time information is stored, for example, in activity information 116 of FIG. 1, although the time information may be stored in local storage. The time information can be used, for example, by an invoice module (e.g., invoice module 360 of FIG. 3) for creating an invoice, or for auditing and analysis purposes. For example, if the status module reports that “On-Hold” status is unexpectedly long for a particular type of field service activity, corrective actions may need to be formulated. If the field service activity status is set to “Declined” or “On hold,” the process is terminated or paused. Otherwise, the flow proceeds to a perform activity operation (operation 420).

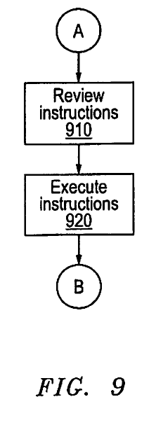

Returning to FIG. 4, the perform activity operation 420 includes the operations shown at FIG. 9. FIG. 9 is a flow diagram showing a detail view of the perform activity operation of FIG. 4. The process of FIG. 9 begins with a review instructions operation (operation 910). At this operation, an instructions module (e.g., instructions module 350 of FIG. 3) retrieves instructions associated with completing the selected field service activity. The instructions can be retrieved, for example, from local storage (e.g., local storage 214 of FIG. 2) or remote storage (e.g., storage device 114 of FIG. 1). The instructions module transfers the instructions to the user interface module, which presents the instructions to the user via the user interface.

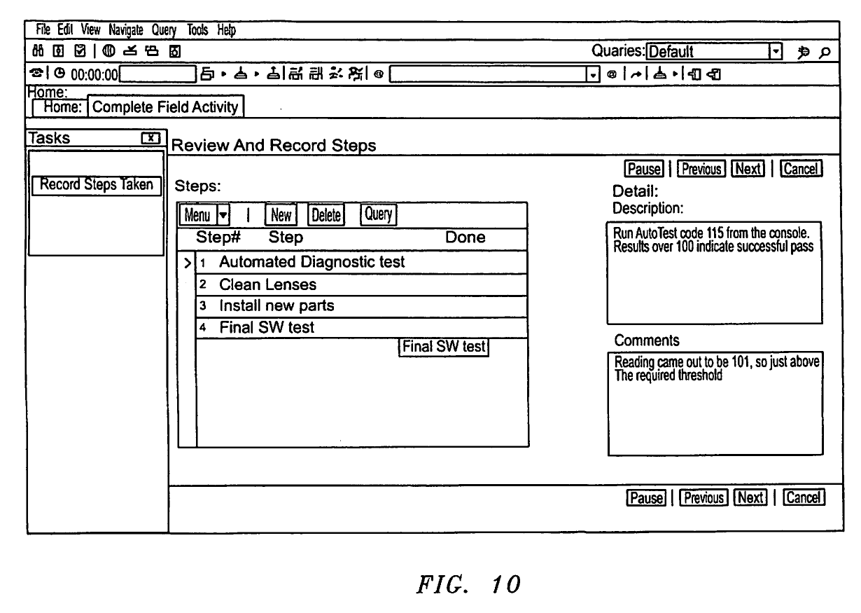

As can be seen in FIG. 10, the instructions can include a list of operations generally used to complete a field service activity. The instructions can also include custom instructions specific to execution of a particular field service activity. For example, if the particular piece of equipment being serviced has a known history of a particular behavior or malfunction, custom instructions can be displayed for that particular piece of equipment.

Execution of the displayed instructions results in the field service activity being performed (operation 920). The user can also enter information concerning the various operations. The user interface module captures any information input by the user and transfers it to local storage or to the database interface module for storage in the storage device.

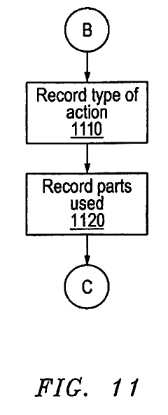

Clicking the “Next” button advances the user to capture activity details operation 430 of FIG. 4, which is depicted by FIG. 11. The process of FIG. 11 begins with a record type of action operation (operation 1110). At this operation, a user enters data indicating what type of field service activity the user performed, such as removing, repairing, or installing a field service asset, for example. The data can be entered as the user works on the field service activity or at a later time. The user interface module captures the input information and can transfer the information to local storage or to the database interface module for storage in the storage device.

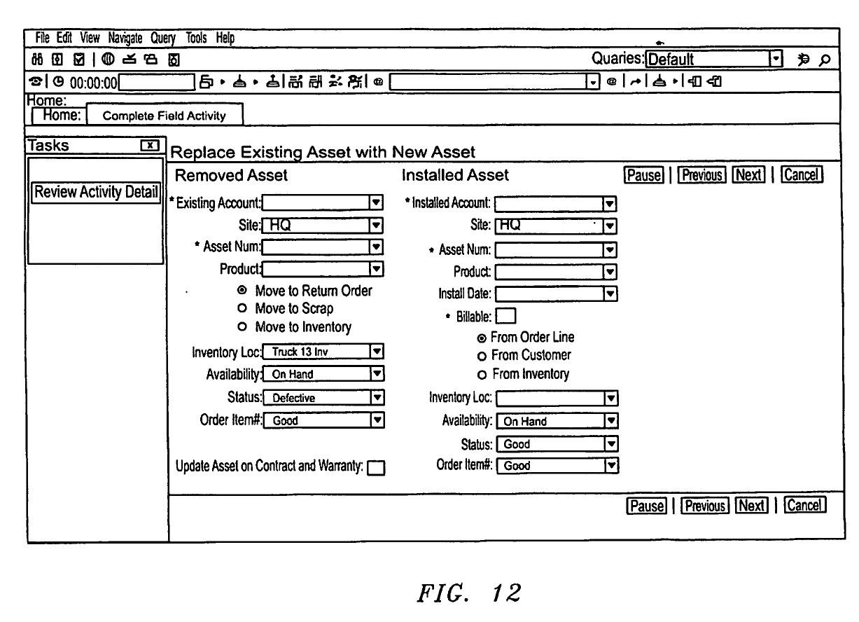

FIG. 12 is an example screenshot showing the record type of action operation of FIG. 11 according to one embodiment of the present invention. The user interface presents fields appropriate to the selected type of action. For example, if a piece of equipment is removed, the user interface presents fields to that the user can record what was done with the removed equipment. Or if a piece of equipment is installed, the user interface presents fields so the user can indicate where the equipment was obtained, e.g., inventory, the customer, etc.

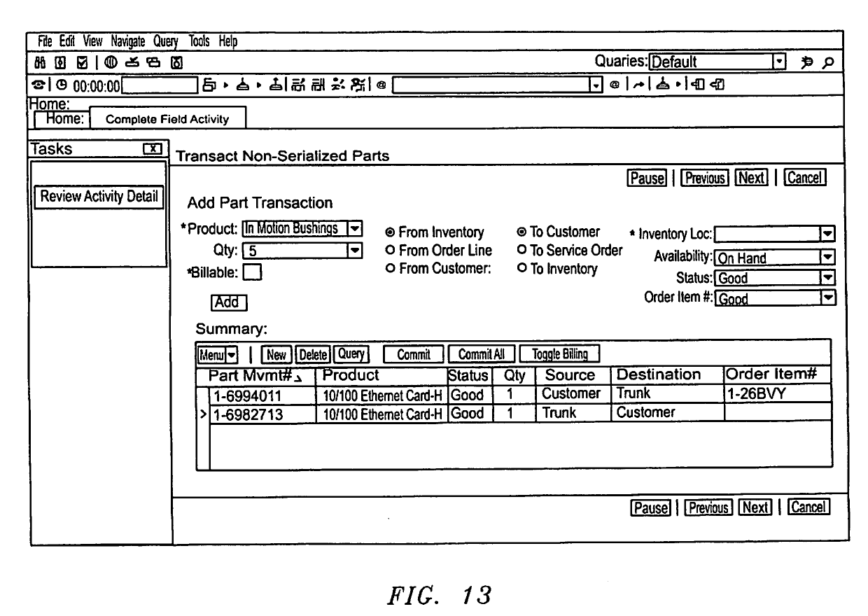

As part of capture activity details operation 430, the user also enters parts used (operation 1120). This data can be used, for example, by the invoice module to generate charges and update inventory. FIG. 13 is an example screenshot showing the record parts used operation of FIG. 11 according to one embodiment. As seen in FIG. 13, the user interface displays fields allowing the user to indicate what parts were used, where the parts were obtained, how the parts were disposed of, and the like.

Data entered by a user is stored in local storage, for example, in local storage 214 of FIG. 2. Such locally stored data is known as transient, or partially committed. When a user completes a field service activity, or puts the field service activity on hold, the user can synchronize, or transfer the captured data to a central location or database via the database interface module. Keeping the data local (transient) until the field service activity is complete allows the user the option of pausing the activity without worrying about the consistency of the data.

For example, if the user needs to wait for a part to be ordered, or if the user is pulled off the job for any reason, the user simply clicks pause in the user interface. The user interface module transfers the input to the status module, which updates the user's status accordingly. The user interface module also transfers the input to the sequence module, which stores information indicating the next step in the process in the remote storage device as part of the synchronization operation. When the user is ready to resume the field service activity, the sequence module will cause the user interface to present the next step in the process so the user can resume the field service activity at the point the user left off.

If the data was stored in a central location (e.g., storage device 114) prior to the user completing the task or synchronizing, resuming a task after a pause would raise the possibility that the data was inadvertently modified (e.g., deleted or overwritten) while the field service activity was paused. If the data stored for a partially complete field service activity were modified, resuming the field service activity where the user left off might be difficult or impossible.

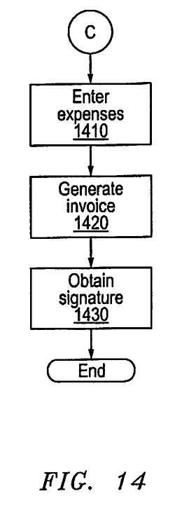

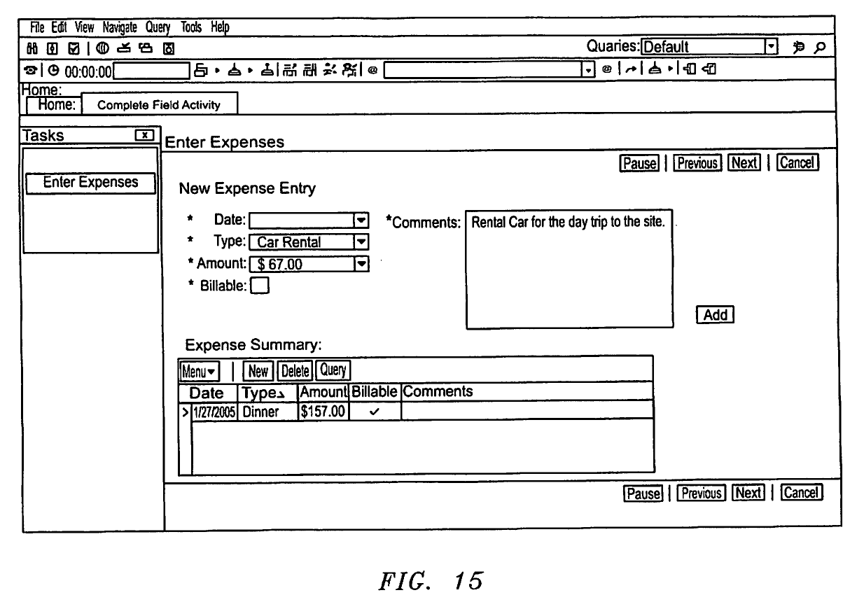

Finally, the process proceeds to the operations depicted in FIG. 14, a flow diagram showing a detail view of the invoice activity operation of FIG. 4 (operation 440), according to one embodiment. At operation 1410, a user enters expenses, such as those shown in FIG. 15. Expenses can include travel expenses and other expenses associated with completing a given field service activity. Next, an invoice module (e.g., invoice module 360 of FIG. 3) calculates the total charge to a customer for completing the field service activity. This includes parts, labor, expenses, and the like. The invoice module can communicate with other modules, such as the status module and the parts module, to collect information needed to calculate the total charges. For example, the invoice module can communicate with the status module to determine the amount of time each status was active. The invoice module can also contact the parts module to determine the cost of parts and supplies.

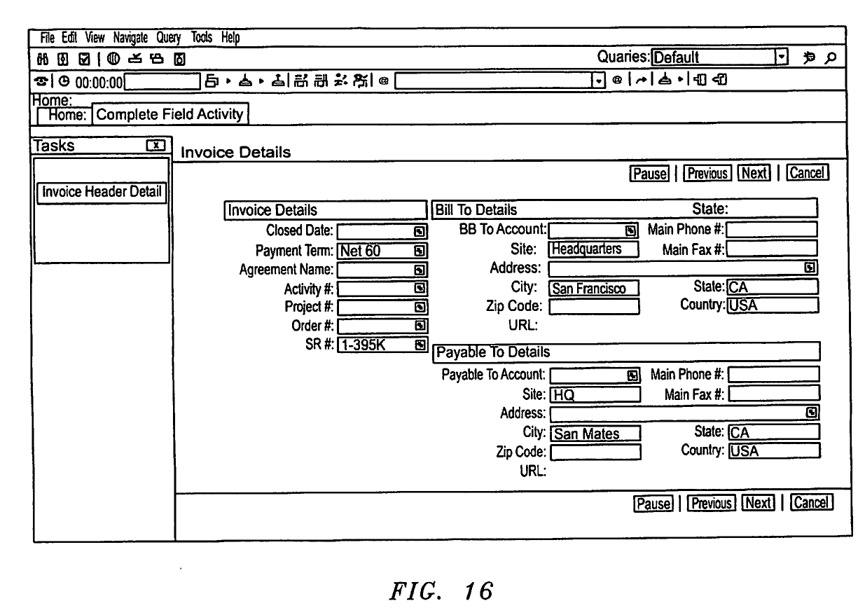

Operation 1420 comprises generating an invoice, as shown in FIG. 16, which is an example screenshot showing the generate invoice operation of FIG. 14. Fields related to the completion of the field service activity can be automatically filled by the invoice module and manually entered by the user.

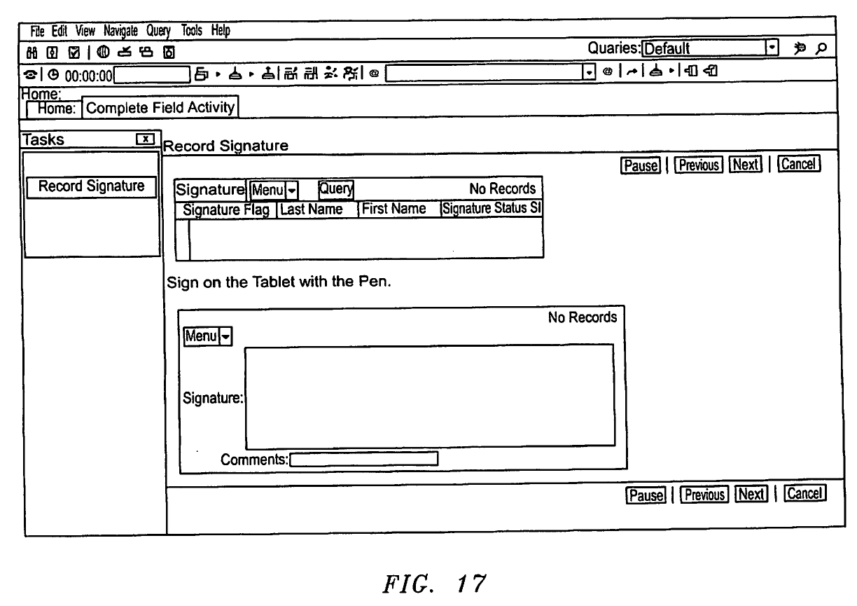

Next, the process proceeds to an obtain signature operation (operation 1430). FIG. 17 is an example screenshot showing the capture signature operation of FIG. 14. A signature is obtained from an authorized representative of the customer. The signature can be captured digitally if, for example, the user has a tablet computer. In the alternative, the invoice can be printed and presented or mailed to the customer for signature. The system also allows a customer to digitally sign the invoice.

The flowcharts provided here are provided as examples. It is noted that other embodiments can include different operations instead of and/or in addition to those shown in the flowcharts presented herein. Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A computer implemented method comprising:
presenting a list of field service activities, wherein
each field service activity in the list comprises an associated plurality of actions, and the actions are performed according to defined sequence;
receiving a selection from the list of field service activities, wherein the selection comprises a selected field service activity; and
completing the selected field service activity, wherein the completing comprises:
automatically presenting an action of a plurality of actions associated with the selected field service activity;
automatically selecting a next action associated with the selected field service activity, in response to data being entered; and
automatically presenting the next action.

2. The computer implemented method of claim 1 wherein
the plurality of actions associated with a field service activity is customizable by a customer.

3. The computer implemented method of claim 1 further comprising:
storing entered data in local storage; and
storing the entered data in a database in response to detecting the selected field service task is completed.

4. The computer implemented method of claim 3 further comprising:
modifying the entered data after the entered data is stored in local storage.

5. The computer implemented method of claim 1 wherein the plurality of actions associated with a field service activity comprises:
acknowledging the field service activity;
performing an action associated with the field service activity;
storing data associated with the performance of the field service activity; and
generating an invoice, wherein
the invoice is associated with the performance of the field service activity.

6. The computer implemented method of claim 5 wherein the generating the invoice further comprises:
displaying the invoice to a client; and
capturing a signature of the client.

7. The computer implemented method of claim 1 further comprising:
receiving data indicating a change in status;
changing a status variable from a first value to a second value, in response to the receiving data indicating a change in status; and
automatically updating a time variable, wherein the time variable indicates how long the status variable was the first value.

8. The computer implemented method of claim 1 further comprising displaying a list of parts, wherein the parts in the list are associated with an action of the sequence.

9. The computer implemented method of claim 1 further comprising providing a plurality of sequences to a customer, wherein
each sequence comprises a plurality of actions, and
each sequence comprises a field service activity.

10. A computer readable storage medium storing instructions, wherein a method is implemented when the instructions are executed, the method comprising:
presenting a list of field service activities, wherein
each field service activity in the list comprises an associated plurality of actions, and the actions are performed according to defined sequence;
receiving a selection from the list of field service activities, wherein the selection comprises a selected field service activity; and
completing the selected field service activity, wherein the completing comprises:
automatically presenting an action of a plurality of actions associated with the selected field service activity;
automatically selecting a next action associated with the selected field service activity, in response to data being entered; and
automatically presenting the next action.

11. The computer readable storage medium of claim 10, wherein.
the plurality of actions associated with a field service activity is customizable by a customer.

12. The computer readable storage medium of claim 10, wherein the method further comprises:
storing entered data in local storage; and
storing the entered data in a database in response to detecting the selected field service task is completed.

13. The computer readable storage medium of claim 12, wherein the method further comprises:
modifying the entered data after the entered data is stored in local storage.

14. The computer readable storage medium of claim 10 wherein the plurality of actions associated with a field service activity comprises:
acknowledging the field service activity;
performing an action associated with the field service activity;
storing data associated with the performance of the field service activity; and
generating an invoice, wherein
the invoice is associated with the performance of the field service activity.

15. The computer readable storage medium of claim 14 wherein the generating the invoice further comprises:
displaying the invoice to a client; and
capturing a signature of the client.

16. The computer readable storage medium of claim 10 wherein the method further comprises:
receiving data indicating a change in status;
changing a status variable from a first value to a second value, in response to the receiving data indicating a change in status; and
automatically updating a time variable, wherein the time variable indicates how long the status variable was the first value.

17. The computer readable storage medium of claim 10 wherein the method further comprises displaying a list of parts, wherein the parts in the list are associated with an action of the sequence.

18. The computer readable storage medium of claim 10 wherein the method further comprises providing a plurality of sequences to a customer, wherein
each sequence comprises a plurality of actions, and
each sequence comprises a field service activity.

19. An apparatus comprising:
a memory system storing a database;
a computer system comprising a memory, wherein the memory stores instructions, wherein the computer system implements a method in response to executing the instructions, the method comprising:
presenting a list of field service activities, wherein
each field service activity in the list comprises an associated plurality of actions, and the actions are performed according to defined sequence;
receiving a selection from the list of field service activities, wherein the selection comprises a selected field service activity; and
completing the selected field service activity, wherein the completing comprises:
automatically presenting an action of a plurality of actions associated with the selected field service activity;
automatically selecting a next action associated with the selected field service activity, in response to data being entered; and
automatically presenting the next action.

20. An apparatus comprising:
means for a presenting a list of field service activities, wherein
each field service activity in the list comprises an associated plurality of actions, and the actions are performed according to defined sequence;
means for receiving a selection from the list of field service activities, wherein the selection comprises a selected field service activity; and
means for completing the selected field service activity, wherein the completing comprises:
automatically presenting an action of a plurality of actions associated with the selected field service activity;
automatically selecting a next action associated with the selected field service activity, in response to data being entered; and
automatically presenting the next action.
